(19) United States
(12) Patent Application Publication
(10) Pub. No.: US 2004/0055410 A1
(43) Pub. Date: Mar. 25, 2004

(54) System for damping vibrations coming from a motor

(75) Inventors: Michael Rosenbauer, Reimlingen (DE); Hubert Groll, Modingen (DE); Herbert Schmidt, Gerstetten (DE); Torbjorn Hansson, Pfalzfeld (DE)

Correspondence Address: John T. Winburn, BSH Home Appliances Corporation, 100 Bosch Blvd, New Bern, NC, 28562, US

(73) Assignee: BSH Bosch und Siemens Hausgerate GmbH, Munich (DE)

(21) Appl. No.: 10/459,736

(22) Filed: Jun. 12, 2003

(30) Foreign Application Priority Data
Dec. 14, 2000 (DE) 10062370.0

(51) Int. Cl. F16F 15/10

(52) U.S. Cl. 74/574

(57) ABSTRACT

A system for damping vibrations coming from a motor, such as a pump motor in a dishwasher. The motor includes a housing and freely oscillating means affixed to the housing for damping the characteristic vibrations of the motor. The oscillating means include at least one mass component affixed to the housing by at least one elastic linkage component.

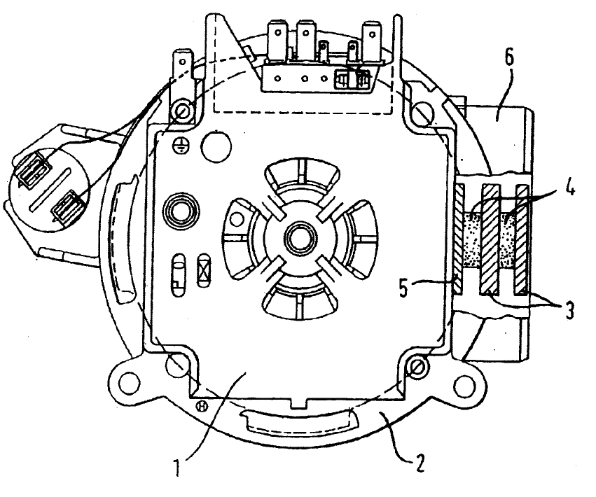

The invention relates to a system for damping vibrations coming from a motor.

Vibrations coming from a motor can cause disagreeable noise to be generated. This is particularly annoying for example in the case of household appliances, in particular, household appliances situated in the living areas of users, for example dishwashers.

It is thus known from DE-A-197 58 249, in a dishwasher, to connect the circulation pump and/or waste water pump driven by an electric motor, of which pump in each case there is at least one, by way of elastic intermediate components to the collection sump of the dishwasher. In this way, transmission of the vibrations coming from the electric motors is largely suppressed, and thus excessive noise generation is counteracted.

The invention is based on the idea of damping right at the source any vibrations that are generated, so that they cannot be transmitted to other components.

According to the invention, this object is met in that affixed to the housing of a motor are freely oscillating means for damping the characteristic vibrations of said motor. By means of such vibration dampers, respective vibrations are damped right at the source, so that they cannot be transmitted to other components.

According to a preferred embodiment of the invention, the freely oscillating means for damping the characteristic vibrations of the motor comprise at least one mass component connected to the motor housing by way of at least one elastic linkage component, wherein in each instance several mass components are connected to at least one elastic linkage component. By connecting a mass component by way of an elastic linkage component, occurring vibrations can be damped very considerably so that they can no longer cause annoying noise generation.

For the purpose of damping system-related pendulum oscillations of the motor, it is particularly advantageous if the mass component and the linkage component are tuned to each other, preferably to approx. 100 Hz oscillations. Tuning the characteristic vibrations of the vibration damper counteracts the system-related pendulum oscillations of the motor, thus reducing the vibration intensity of the motor. Practical application has shown that, in particular, tuning to 100 Hz oscillations is particularly effective.

Advantageously, the freely oscillating means for damping the characteristic vibrations of the motor are accommodated in a box-type cover arranged on the motor housing. In this way, there is no further interference from the mass components and linkage components protruding beyond the external contours of the motor housing. At the same time this ensures that when installed in a household appliance, said components do not rest against other components of the household appliance, which would lead to interference in their vibration behaviour.

According to a preferred embodiment of the invention, the freely oscillating means for damping the characteristic vibrations of the motor are affixed to a motor used in a water-bearing household appliance, advantageously to a motor of a pump used in a water-bearing household appliance, particularly advantageously to a motor of a circulation pump of a dishwasher. With these measures, in the case of household appliances e.g. water-bearing household appliances, and in particular in the case of dishwashers, the advantages of the invention are applied because it is precisely with household appliances which are situated in the living area of a user, where noise generation is particularly annoying.

The invention thus also relates to a dishwasher in which on a housing of the motor of at least one circulation pump and/or evacuation pump, the freely oscillating means, according to the invention, for damping the characteristic vibrations of the motor are affixed.

Below, the invention is explained in more detail by means of an embodiment shown in the drawing.

Particularly in the case of household appliances, e.g. water-bearing household appliances and more particularly in the case of dishwashers which are situated in the living area of a user, noise generation is particularly annoying. In the exemplary embodiment, the system according to the invention is shown using the example of a circulation pump (not described in further detail) of a dishwasher (also not described in further detail).

1 denotes an electric motor, in top view, which drives the circulation pump. According to the invention, on the outside of the motor housing 2, freely oscillating means 3, 4 for damping the characteristic vibrations of the motor 1 are mounted, namely at least one mass component 3 connected to the motor housing 2 by way of at least one elastic linkage component 4; in the embodiment shown there are two mass components 3, which are connected by way of an elastic linkage component 4, wherein a further elastic linkage component 4 is used for connection to an attachment plate 5, which is attached to the motor housing 2.

The mass components 3 and the linkage components 4 are attuned to each other such that they provide particularly good damping to the system-related pendulum oscillations coming from the electric motor; in the embodiment described these are 100 Hz oscillations, i.e. in the embodiment described, the characteristic frequency of mass components 3 and linkage components 4 is approx. 100 Hz.

To prevent the mass components 3 and linkage components 4, which protrude beyond the external contours of the motor housing, from interfering, they are advantageously accommodated in a box-type cover 6 arranged on the motor housing. At the same time this ensures that when installed in a household appliance, said components do not rest against other components of the household appliance, which would lead to interference with their vibration behaviour.

With the system according to the invention it is possible to damp right at the source any vibrations that are generated, so that they cannot be transmitted to other components.

1. A system for damping vibrations coming from a motor, characterised in that affixed to a housing (2) of the motor (1) are freely oscillating means (3, 4) for damping the characteristic vibrations of the motor (1).

2. The system according to claim 1, characterised in that the freely oscillating means (3, 4) for damping the characteristic vibrations of the motor (1) comprise at least one mass component (3) connected to the motor housing (2) by way of at least one elastic linkage component (4), wherein several mass components (3) are connected to at least one elastic linkage component (4).

3. The system according to claim 1 or 2, characterised in that for damping system-related pendulum oscillations of the motor (1), the mass component (3) and the linkage component (4) are tuned to each other, preferably to approx. 100 Hz oscillations.

4. The system according to any one of claims 1 to 3, characterised in that the freely oscillating means (3, 4) for damping the characteristic vibrations of the motor (1) are housed in a box-type cover (6) arranged on the motor housing (2).

5. The system according to any one of claims 1 to 4, characterised in that the freely oscillating means (3, 4) for damping the characteristic vibrations of the motor (1) are affixed to a motor (1) used in a water-bearing household appliance.

6. The system according to claim 5, characterised in that the freely oscillating means (3, 4) for damping the characteristic vibrations of the motor (1) are affixed to a motor (1) of a pump used in a water-bearing household appliance.

7. The system according to claim 6, characterised in that the freely oscillating means (3, 4) for damping the characteristic vibrations of the motor (1) are affixed to a motor (1) of a circulation pump of a dishwasher.

8. A dishwasher, characterized in that on a housing (2) of the motor (1) of at least one circulation pump and/or evacuation pump, freely oscillating means (3, 4) for damping the characteristic vibrations of the motor (1) are affixed.
